(19) United States
(12) Patent Application Publication
(10) Pub. No.: US 2023/0015734 A1
(43) Pub. Date: Jan. 19, 2023

(54) A METHOD AND SYSTEM FOR ROBOTIC WELDING

(71) Applicant: Inrotech A/S, Odense Sø (DK)

(72) Inventors: Alex Tinggaard Årsvold, Odense (DK); Andreas Sørensen Zeltner, Odense C (DK); Flemming Jørgensen, Odense Sv (DK); Rasmus Faudel, Odense M (DK)

(21) Appl. No.: 17/783,246

(22) PCT Filed: Dec. 10, 2020
(86) PCT No.: PCT/EP2020/085559

§ 371 Date: Jun. 7, 2022

(30) Foreign Application Priority Data
Dec. 10, 2019 (DK) PA 201970758

(51) Int. Cl. B23K 9/095; B23K 31/12; B23K 31/00

(52) U.S. Cl. CPC B23K 9/0953; B23K 31/125; B23K 31/006

(57) ABSTRACT

A method and a system for controlling a welding operation is provided by a welding machine controlled by an automatic motion generating mechanism. The method includes the steps of acquiring a set of welding data during the welding operation; computing at least a first part of the set of welding data and at least a second part of the set of welding data providing computed data, wherein the computed data indicate an abnormality; and transferring an abnormality output to a robot controller, which is controlling the welding machine and the automatic motion generating mechanism.

### CROSS-REFERENCE TO RELATED APPLICATIONS

This application is the U.S. National Stage of PCT/EP2020/085559 filed on Dec. 10, 2020, which claims priority to Denmark Patent Application PA 201970758 filed on Dec. 10, 2019, the entire content of both are incorporated herein by reference in their entirety.

### FIELD OF THE INVENTION

The present invention relates to a method and a system for robotic welding.

### BACKGROUND OF THE INVENTION

In manufacturing industry robots are used to perform accurate, highly precise operations every day. Many of these industrial robots are programmed to perform the same exact motions and to repeat these many times a day. Accordingly, robotic welding systems are commonly used to accurately and repeatedly weld components together in industries like the automotive industry as well as in heavy industry, such as in shipyards. Whereas welding applications in the automotive industries were dominated by pre-programmed welding programs, the welding processes in the heavy industries are dominated by tasks that differ between each run as the welding operations are complex with huge tolerances of the components.

From the prior art, e.g. U.S. Pat. No. 6,011,241 and US 2012/0091185 A1, it is known to provide the robotic arc-welding system with a vision system so that the system has the capability of tracking a welding seam and to adjust welding parameters to compensate for tolerances.

From WO2019/106425 there is known a method and system using a smart torch with positional tracking in robotic welding. According to this system, the absolute position of the welding torch is determined, e.g. by TAST feedback (TAST: Through Arc-sensor Seam Tracking). The relative position of the welding torch relative to the welding path is determined. The system calculates a correction vector based on 5-10 cycles so the welding torch can automatically follow the weld path.

One of the difficult elements of programming a robotic welding application is to detect and deal with abnormalities when the robot is performing a welding operation. As an example of an abnormality could be drain holes. An abnormality can be of missing of material due to the presence of a water hole or drain hole or other types of cut-outs in the welding path. These are frequently used in the shipbuilding and can have random positions on the welding area. Another type of abnormalities could be weld tacks for preliminary fixation of the pieces prior to the welding. Detecting drain holes or similar abnormalities with scanners and sensors prior to the robotic welding is time consuming and inefficient. Besides drain holes and weld tacks, also end of profile or lack of gas as well as gap tolerances are also considered as abnormalities that can lead to welding errors when performing a robot welding.

In the present disclosure, by the term abnormalities is meant interferences with the pre-programmed (and thereby normal) robotic welding operation.

### SUMMARY OF THE INVENTION

With this background, it is an object of the present invention to provide a method and a system whereby a welding machine, such as a robot, automatically can detect when to react on a detection of an abnormality by either signalling, stopping, pausing or changing the welding task.

In a first aspect of the invention, this object is achieved by a method of controlling a welding operation provided by a welding machine controlled by an automatic motion generating mechanism, the method comprising the steps of

acquiring a set of welding data during the welding operation;

computing at least a first part of the set of welding data and at least a second part of the set of welding data providing computed data, wherein the computed data indicate an abnormality;

optionally transferring an abnormality output to a robot controller, which is controlling the welding machine and the automatic motion generating mechanism.

In a second aspect of the invention, this object is achieved by a method of controlling a welding operation by automatic detection of welding abnormalities executing a welding operation by operating a welding machine by a motion mechanism, said method comprising the steps of:

acquiring welding data during the welding operation, and supplying said welding data to a detection unit, which comprises a neural network-based abnormality detection system;

computing the data in a neural network, such as a Long Short-Term Memory (LSTM) network, and producing a neural network output, which is forwarded to a post-processor;

detecting if an abnormality is detected in said post-processor by preparing and buffering incoming neural network output signals and then processing a plurality of buffered signals to produce an abnormality detection decision output; and

transferring this abnormality detection decision output to a robot controller, which is controlling the welding machine and the automatic motion generating mechanism.

In a third aspect of the invention, the object is achieved by the provision of a system for controlling a welding operation by automatic detection of a welding abnormality, said system comprising

a welding machine with a welding gun configured for performing a welding operation;

an automatic motion generating mechanism configured for moving the welding gun along a welding path during the welding operation;

a robot controller configured for controlling the welding operation performed by the welding machine and the movements of the automatic motion generating mechanism;

a processor unit;

wherein the processor unit is configured for

receiving a set of welding data characterising the welding operation,

computing an output based on at least a first part of the set of welding data and at least a second part of the set of the welding data providing computed data, wherein the computed data indicate an abnormality,

providing an abnormality output, and

optionally transferring the abnormality output to the robot controller.

In a fourth aspect of the invention, the object is achieved by the provision of a system for controlling a welding operation by automatic detection of welding abnormality, said system comprising: a welding machine for performing a welding process; an automatic motion generating mechanism for moving the welding gun of the welding machine along a welding path; and a robot controller, which is monitoring and controlling the welding process performed on the welding machine and the movements of the automatic motion generating mechanism; wherein the robotic controller is provided with a detection unit which is receiving welding data during the welding operation; said detection unit comprising a neural network-based abnormality detection system, such as a Long Short-Term Memory (LSTM) network, for computing the welding data to produce a neural network output, which is forwarded to a post-processor, wherein it is detected if an abnormality in the welding operation by preparing and buffering incoming neural network output signals and then processing a plurality of buffered signals to produce an abnormality detection decision output; and transferring this abnormality detection decision output to a robot controller, which is controlling the welding machine and the automatic motion generating mechanism.

By methods and systems according to the invention there is achieved automatically detection of an abnormality in the welding process and so that the system is enabled to stopping, pausing or changing a welding task accordingly. If there is an abnormality, the abnormality will be detected immediately, so that the welding operation can immediately be stopped, the abnormality removed, if necessary, and welding repeated. By the method and the system of the present invention, the abnormality will result in the minimum of lost time and costs. Alternatively, a warning can be issued so that a person is made aware of the abnormality and can correct the abnormality in the optimal way. No abnormality in the welding operation will be forgotten.

The abnormality can be due to lack of material close to the welding path in at least one of the pieces to be welded together, so that the welding operation is temporarily interrupted or at least influenced. If the welding operation is interrupted, the welding current (the welding current is the current jumping in the welding arc) of a current based welding operation will go down to zero, while if the welding operation is just influenced, the welding current will decrease somewhat but not necessarily go down to zero. In both situations, the welding operation at that spot, where the welding operation was interrupted or influenced, will be inferior and may have to be redone.

Alternatively, the welding quality can be detected by a microphone positioned close to the welding spot, e.g. positioned in the welding gun. The welding spot will generate one type of noise when the welding is optimal/normal or close to optimal and another noise when the welding is interrupted, due to lack of material e.g. like a drain hole, or because the weld gun is moved too far away from the welding spot. The welding operation may comprise an inert shielding gas that is applied around and over the welding operation to prevent oxidisation. Without the inert shielding gas, the hot weld will oxidise. A third type of noise is generated if there is not enough inert shielding gas, so that the If a hose gets squeezed or breaks, the supply of gas may be influenced and even be interrupted, which may lead to a weld of inferior quality due to e.g. oxidisation. The microphone may pick up the different noises and the method and the system according to the present application will issue a warning that the welding is inferior, or take care of inferior welding by removing the old inferior welding and apply a new welding.

The inert shielding gas will enter the spot of the welding operation through a hose, which may comprise a flow sensor, which issues flow data about the flow of the inert shielding gas, wherein the flow data can be the welding data.

The inert shielding gas is in most cases stored in gas cylinders, which will eventually become empty. If that happens, the supply of gas may be influenced and even be interrupted, which may lead to a weld of inferior quality due to oxidisation.

The set of welding data can be received from the welding machine or the system comprises external sensors, like e.g. the flow sensor, for monitoring the welding data.

At least a part of the acquired set of welding data can comprise subsequently recorded welding data. Using several welding data points of the same type of welding data (welding current, welding voltage, gas flow, etc.), which are e.g. averaged, eliminates the risk that one single fault in the measurement or acquirement of welding data results in false alarm. The several welding data points may be buffered and compared to each other to eliminate welding data points, which are obviously wrong—like e.g. one single data point indicates no welding operation while all other welding data both before and after the single data point indicate normal welding operation. But if there are e.g. two, three or more data points in a row in time indicate no or inferior welding operation, the abnormality output may have to be transferred.

Of course, if the sampling rate is low like e.g. less than 1 Hz or less than 0.1 Hz, one single welding data point that indicates no or inferior welding operation may be true so that the abnormality output should be transferred. For that reason it may be advantageous to have a sampling rate of at least 1 Hz, preferably at least 10 Hz even more preferably at least 50 Hz so that the abnormality output will be based on two or more and preferably several welding data points that indicates an abnormality. That will reduce the number of false abnormality outputs. A higher sampling rate will also reduce the risk that an abnormality occurring during a short time interval is not detected. Most preferably, the sampling rate can be around 100 Hz.

The step of computing the at least first part of the set of welding data and the at least second part of the set of welding data involves calculating a standard deviation of a number of measured welding data. The standard deviation may be calculated based on between 10 to 100 measurements, preferably between 20 to 70 measurements, more preferably between 25 to 50 measurements, such as 30 measurements. So the standard deviation may be calculated based on a certain number of measurements. For each new welding data that is measured the oldest welding data of the certain number of welding may be discarded, so that the number of welding data underlying the calculation of the standard deviation can always be constant. The higher number of measurements used for calculating the standard deviation, the less is the risk for false alarms. If the number of measurements used are too high, the processing time will be too long or the processing unit will have to be unnecessarily complicated.

The calculated standard deviation can be the standard deviation of the welding current, the welding voltage, or the output from the microphone recording the noise close to the welding spot.

The calculated standard deviation can be compared to a threshold value. If the standard deviation exceeds the threshold value or exceeds the threshold value during a certain number of subsequently calculated threshold values, the abnormality output can be transferred to the robot controller. That the threshold value has to be exceeded during a certain number of subsequently calculated threshold values means that the risk for false alarms about an inferior welding is reduced.

If e.g. the welding current is too high or too low, the standard deviation will exceed the threshold, and the abnormality output will be transferred to the robot controller. If the microphone picks up another noise, the calculated standard deviation of the output from the microphone will exceed the threshold, and the abnormality output will be transferred to the robot controller.

The threshold will have to be set to the right level, so that no false alarms are issued and no inferior welding will be missed. After some testing, the level of the threshold can be determined.

Instead of computing the standard deviation, the derivative of the standard deviation of the welding data can be computed. It has turned out that comparing the derivative of the standard deviation of the welding data to a threshold level is less system dependent, so that the same threshold level can be used for many different systems as long as the welding data is of the same type, welding current, welding voltage, noise from the microphone, etc.

In an embodiment, a neural network is used for computing the at least first part of the set of welding data and the at least second part of the set of the welding data. Thus by the invention, there is advantageously achieved utilization of machine learning for controlling the welding process.

The well-trained neural network will correctly interpret when the welding data indicate no or inferior welding operation or not.

At least a part of the acquired set of welding data can be used to build up the neural network. The accuracy of the neural network will increase with time.

Preferably, the welding operation is an automatic arc-welding operation. The motion mechanism is preferably an automatic motion mechanism, such as a robot. However, by the invention it is realized that the method and the system according to the invention may also be used in a semi-automatic or manually controlled welding operation.

The welding data detected may include the welding current, the welding voltage, the energy used for the welding and/or arc-sensor signals, such as signals relating to Through Arc-sensor Seam Tracking (TAST). The feed-back from the welding process may also include further welding data such as one or more of the following: voltage, welding current (amperage), welding wire feed speed, gas flow, gas pressure, temperature, wind, etc. By the invention, it is also realised that sound measurements could be used as feed-back signals from the welding operation to the detection unit or the processing unit to control the welding process.

In an embodiment, the detection unit or the processing unit can comprise a pre-processor for preparing the collected data for the neural network. Furthermore, the detection unit or the processing unit preferably comprises a Long Short-Term memory (LSTM) network.

In an embodiment of the invention, the step of the neural network output can be squared and then recorded in a short memory queue, whereafter the average of the buffer can be calculated and compared with welding parameters to produce a decision signal, which is added to a buffer, said detection signal can be a binary signal representing either abnormality detected or abnormality not detected. Hereby, the abnormality detection decision output can be produced based on a predetermined number of decision signals in the buffer, such as 10 decision signals, preferably where a positive detection decision is the outcome of a majority of the detection signals in the buffer.

In an embodiment of the invention, the automatic motion generating mechanism can be a robot, which can e.g. be able to read the surroundings and adapt based on the readings to perform the necessary set of movements.

In an embodiment of the invention, the automatic motion generating mechanism can be a motion generating mechanism, where the motion generating mechanism is pre-programmed to perform a set of movements.

### BRIEF DESCRIPTION OF THE DRAWINGS

In the following the invention is described in more detail with reference to the accompanying drawings, in which:

FIG. 1 is a diagram of the process components in a system according to the invention;

FIG. 2 is a schematic perspective view of an example of a welding operation including abnormalities;

FIG. 3 is a graph of the standard deviation of welding current as a function of time and the corresponding abnormality output;

FIG. 4 is a graph of the derivative of the standard deviation of welding current as a function of time and the corresponding abnormality output.

### DETAILED DESCRIPTION OF THE INVENTION

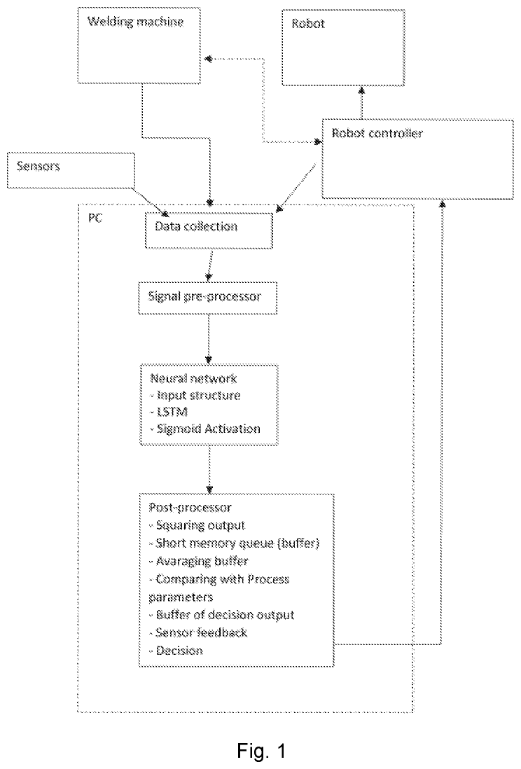

In the system according to the invention and as exemplified in the diagram of FIG. 1, the robot can automatically detect an abnormality in the welding process and based on the feed-back data the system is capable of signalling, stopping, pausing or changing a welding task accordingly. An abnormality can be missing of material due to the presence of a water hole (i.e. drain hole) or other type of cut-out in the welding path. It can also be prior welding marks, such as tacks, gaps between elements or simply be unexpected change of the welding seam.

The system comprises a welding machine used to weld material together in an automatic or semi-automatic manner. A robotic or similar automated motion generating mechanism (hereafter referred to as a robot) moves the welding gun of the welding machine while welding the material. The welding machine and the robot are controlled by a robot controller. During welding welding data on how the process is running is collected. The welding data may be collected from the welding machine or by a number of sensors, like e.g. a gas flow sensor, or a microbolometer. In a detection unit or a processing unit, such as a PC, the collected data is analysed and upon detection of an abnormality, the signal thereof is transferred to handle the detection.

The collected data can be process parameters, such as but not limited to the welding current, the welding voltage, air flow, gas flow, welding material consumption, the energy used for the welding and Arc-sensor signals, such as Through Arc-sensor Seam Tracking (TAST). It is by the invention realised that other types of data could also be collected in addition to or instead of one or more of the here mentioned types of data. The collected data is then passed on to the detection unit or the processing unit.

The detection unit or the processing unit can comprise any or all of a pre-processor, a neural network and a post-processor. The signal pre-processor receives the collected data receives the collected data and prepares it to the input structure of the neural network.

The neural network is built up as a sequential model comprising a Long Short-Term Memory (LSTM) network with e.g. 600 neurons or cells. The model consists of a dense layer that collects the network to a single output, using a sigmoid activation function. A random neural network can also be used.

The output from the network is passed through to the post-processing segment to determine if the robot should stop or not. This process begins by squaring the output from the network, this value is added to a short memory queue. The average of this buffer is then compared to a threshold, which is adjusted based on welding parameters.

This comparison then determines if a missing material has been detected or not. To avoid hysteresis in the detections, the decision is added to a buffer of the past 10 decisions, and if this buffer has more than 5 votes for a missing material existing, the post-processor issues a positive detection, and a signal is sent to further processing to handle the detections. Often, this results in the robot controller or program logic will stop the welding and search for a new start position.

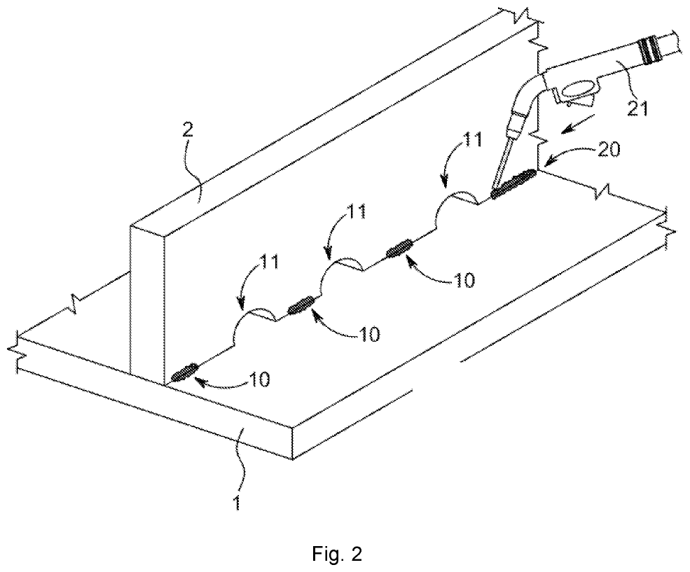

In FIG. 2, a schematic illustration of a welding job with abnormalities is shown. Two steel plates 1, 2 are positioned relative to each other. The second steel plate 2 is positioned abutting the first steel plate 1. To hold the second steel plate 2 in position it is tack welded 10 at some locations as a preliminary fixation to the first steel plate 1. As shown, the abutting plate 2 is provided with drain holes 11 so that water can be drained in the finished work piece. The welding gun 21 is controlled by the welding machine (not shown) and moved along the welding path 20 by a robot (not shown). As the welding process takes place the abnormalities, which in the illustrated example are drain holes 11 and weld tacks 10 are detected and processed so the welding machine is properly corrected so that the quality of the welding operation is ensured.

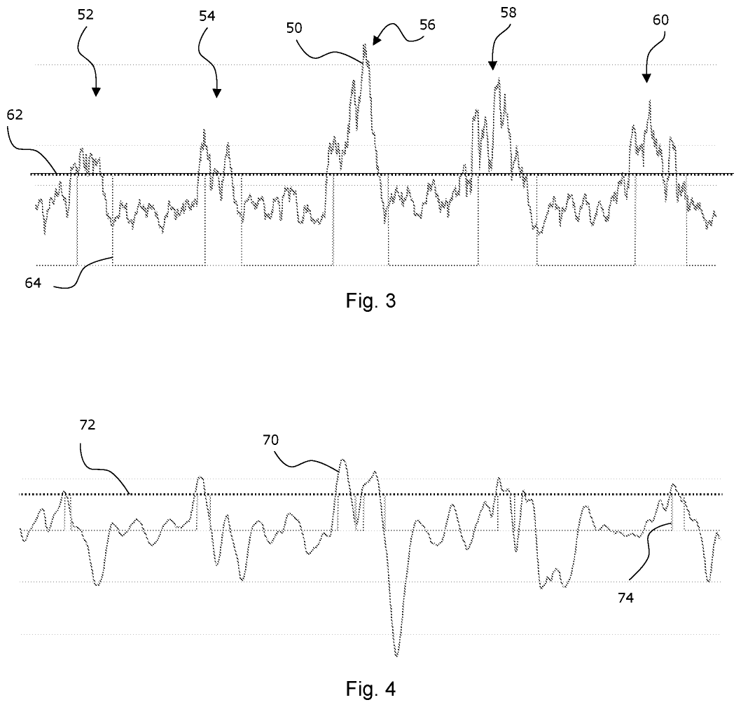

FIG. 3 shows a signal 50 of a standard deviation of a welding current versus time from an arc-welding operation. In the presented time window the standard deviation increases five times shown as five peaks (52,54,56,58,60). In between the peaks, the standard deviation is relatively stable indicating a stable welding operation. The increased standard deviation at the five peaks indicates that something has happened that has influenced the welding operation so that the welding operation is not optimal or normal.

The welding data, here in the form of the welding current, are computed to achieve the standard deviation. In this example, when several subsequent calculated standard deviations are above a predefined threshold 62, a first abnormality output 64 is set to one. When several subsequent standard deviations are below the predefined first threshold 62, the first abnormality output 64 is set to zero.

FIG. 4 shows a derivative 70 of the signal 50 presented in FIG. 3. The time period in FIG. 4 is the same as in FIG. 3. The presented data, here in the form of the derivative of the standard deviation of the welding current, are computed. In this example, when several subsequent derivatives of the standard deviation are above a predefined second threshold 72, a second abnormality output 74 is set to one. When several subsequent derivatives of the standard deviation are below the predefined threshold, the second abnormality output 74 is set to zero.

### Items

1. A method of controlling a welding operation by automatic detection of welding abnormalities executing a welding operation by operating a welding machine by a motion mechanism, said method comprising the steps of:

acquiring welding data during the welding operation, and supplying said welding data to a detection unit, which comprises a neural network-based abnormality detection system;

computing the data in a neural network, such as a Long Short-Term Memory (LSTM) network, and producing a neural network output, which is forwarded to a post-processor;

detecting if an abnormality is detected in said post-processor by preparing and buffering incoming neural network output signals and then processing a plurality of buffered signals to produce an abnormality detection decision output; and

transferring this abnormality detection decision output to a robot controller, which is controlling the welding machine and the automatic motion generating mechanism.

2. A method according to item 1, whereby the welding operation is an automatic arc-welding operation.
3. A method according to any one of items 1 or 2, whereby the motion mechanism is an automatic motion mechanism, such as a robot.
4. A method according to any one of the preceding items, whereby the welding data includes the welding current, the welding voltage, the energy used for the welding and/or arc-sensor signals, such as signals relating to Through Arc-sensor Seam Tracking (TAST).
5. A method according to any one of the preceding items, whereby the detection unit comprises a pre-processor for preparing the collected data for the neural network.
6. A method according to any one of the preceding items, whereby the detection unit comprises a Long Short-Term memory (LSTM) network.
7. A method according to any one of the preceding items, whereby the step of the neural network output is squared and then recorded in a short memory queue, whereafter the average of the buffer is calculated and compared with welding parameters to produce a decision signal, which is added to a buffer, said detection signal is a binary signal representing either abnormality detected or abnormality not detected.
8. A method according to any one of the preceding items, whereby the abnormality detection decision output is produced based on a predetermined number of decision signals in the buffer, such as 10 decision signals, preferably where a positive detection decision is the outcome of a majority of the detection signals in the buffer.
9. A system for controlling a welding operation by automatic detection of welding abnormality, said system comprising:

a welding machine for performing a welding process;

an automatic motion generating mechanism for moving the welding gun of the welding machine along a welding path; and

a robot controller, which is monitoring and controlling the welding process performed on the welding machine and the movements of the automatic motion generating mechanism; wherein

the robotic controller is provided with a detection unit which is receiving welding data during the welding operation; said detection unit comprising a neural network-based abnormality detection system, such as a Long Short-Term Memory (LSTM) network, for computing the welding data to produce a neural network output, which is forwarded to a post-processor, wherein it is detected if an abnormality in the welding operation by preparing and buffering incoming neural network output signals and then processing a plurality of buffered signals to produce an abnormality detection decision output; and transferring this abnormality detection decision output to a robot controller, which is controlling the welding machine and the automatic motion generating mechanism.
10. A system according to item 9, wherein the welding operation is an automatic arc-welding operation.
11. A system according to any items 9 or 10, wherein the welding data includes the welding current, the welding voltage, the energy used for the welding and/or arc-sensor signals, such as signals relating to Through Arc-sensor Seam Tracking (TAST).
12. A system according to any one of items 9 to 11, wherein the detection unit comprises a pre-processor for preparing the collected data for the neural network.
13. A system according to any one of items 9 to 12, wherein the Long Short-Term memory (LSTM) network comprises at least 600 neurons or cells.
14. A system according to any one of items 9 to 13, wherein the output or the neural network output is squared in the post-processor and then recorded in a short memory queue, whereafter the average of the buffer is calculated and compared with welding parameters to produce a decision signal, which is added to a buffer, said detection signal is a binary signal representing either abnormality detected or abnormality not detected.
15. A system according to any one of items 9 to 14, wherein the abnormality detection decision output is produced based on a predetermined number of decision signals in the buffer, such as 10 decision signals, preferably where a positive detection decision is the outcome of a majority of the detection signals in the buffer.

1.-16. (canceled)

17. A method of controlling a welding operation provided by a welding machine controlled by an automatic motion generating mechanism, the method comprising the steps of:
acquiring a set of welding data during the welding operation;
computing at least a first part of the set of welding data and at least a second part of the set of welding data providing computed data, wherein the computed data indicate an abnormality;
transferring an abnormality output to a robot controller, which is controlling the welding machine and the automatic motion generating mechanism.

18. The method according to claim 17, wherein the step of computing the at least first part and the at least second part is performed by a neural network.

19. The method according to claim 17, wherein the welding operation is an arc-welding operation, or an automatic arc-welding operation, or a resistance welding operation.

20. The method according to claim 17, wherein the welding data comprises the welding current, the welding voltage, the energy used for the welding, flow of gas, arc-sensor signals, or arc-sensor signals relating to Through Arc-sensor Seam Tracking (TAST).

21. The method according to claim 18, wherein the method comprises the step of preparing the acquired welding data for the neural network.

22. The method according to claim 17, wherein the robot controller, when the abnormality output is received, controls the automatic motion generating mechanism and the welding machine to redo at least a part of the welding operation.

23. The method according to claim 17, wherein the robot controller receives a normality output as long as no abnormality is detected when computing the at least first part and the at least second part.

24. The method according to claim 18, wherein the neural network provides a neural network output indicating abnormality based on the step of computing the at least first part and the at least second part performed by the neural network, wherein the provision of the neural network output indicating abnormality initiates the transferring of the abnormality output to the robot controller.

25. The method according to claim 24, wherein a plurality of neural network outputs are buffered, and the plurality of buffered neural network outputs are processed together for providing the abnormality output.

26. The method according to claim 25, wherein the neural network output is squared and then recorded in a short memory queue, whereafter the average of the buffered neural network outputs is calculated and compared with welding parameters to produce a decision signal, said detection signal is a binary signal representing either abnormality or no abnormality detected.

27. A system for controlling a welding operation by automatic detection of a welding abnormality, said system comprising:
a welding machine with a welding gun configured for performing a welding operation;
an automatic motion generating mechanism configured for moving the welding gun along a welding path during the welding operation;
a robot controller configured for controlling the welding operation performed by the welding machine and the movements of the automatic motion generating mechanism;
a processor unit;
wherein the processor unit is configured for:
receiving a set of welding data characterizing the welding operation, computing an output based on at least a first part of the set of welding data and at least a second part of the set of welding data providing computed data, wherein the computed data indicate an abnormality,
providing an abnormality output, and
transferring the abnormality output to the robot controller.

28. The system according to claim 27, wherein the processor unit comprises a neural network, wherein the neural network is configured for computing the output based on the at least first part and the at least second part for detecting abnormalities in the welding operation.

29. The system according to claim 27, wherein the welding operation is an arc-welding operation, or an automatic arc-welding operation, or a resistance welding operation, or a gas welding operation.

30. The system according to claim 27, wherein the welding data comprises welding current, welding voltage, energy used for the welding operation, flow of a welding gas, flow of an inert shielding gas, arc-sensor signals, or arc-sensor signals relating to Through Arc-sensor Seam Tracking (TAST).

31. The system according to claim 27, wherein the processing unit comprises a pre-processor for preparing the collected data for the neural network.

32. The system according to claim 27, wherein the neural network is a the Long Short-Term memory (LSTM) network comprising at least 600 neurons or cells.
